(19) United States
(12) Patent Application Publication
(10) Pub. No.: US 2014/0327532 A1
(43) Pub. Date: Nov. 6, 2014

(54) METHOD OF PREVENTING COLLISION IN VEHICLE

(71) Applicant: MANDO CORPORATION, Pyeongtaek-si (KR)

(72) Inventor: MAN BOK PARK, Seoul (KR)

(73) Assignee: MANDO CORPORATION, Pyeongtaek-si (KR)

(21) Appl. No.: 14/266,967

(22) Filed: May 1, 2014

(30) Foreign Application Priority Data
May 3, 2013 (KR) 10-2013-0050328

(51) Int. Cl. B60Q 5/00

(52) U.S. Cl. CPC B60Q 5/006
USPC 340/435

(57) ABSTRACT

Provided is a method of preventing a collision of vehicles at an intersection, including calculating position information of a subject vehicle approaching the intersection and position information of an opposite vehicle approaching another approach path to the intersection, calculating intersection approach times of the subject vehicle and the opposite vehicle based on the position information, calculating an approach time difference between the intersection approach time of the subject vehicle and the intersection approach time of the opposite vehicle, and performing a follow-up action depending on the approach time difference.

### BACKGROUND

1. Field of the Invention

The present invention relates to a method of preventing a collision of vehicles at an intersection, and more particularly, to a method of preventing a collision of vehicles at an intersection capable of calculating an approach time difference according to intersection approach times of a subject vehicle and an opposite vehicle to stably prevent the collision.

2. Discussion of Related Art

In general, the accident rate at an intersection is much higher than that of other roads, and thus, careful driving at the intersection is very important.

However, such an accident at the intersection cannot be completely solved by a driver's safety consciousness and caution only, and thus, intersection collision prevention systems using various methods are being developed and applied.

However, the intersection collision prevention systems developed and applied in the related art have a complex process of calculating a collision time of vehicles, and poor calculation precision.

In addition, a follow-up action after calculation of the collision time is unclear so that the accident rate at an intersection is not remarkably reduced.

Accordingly, a method of solving the above-mentioned problems is needed.

### SUMMARY OF THE INVENTION

The present invention is directed to provide a method of preventing a collision of vehicles at an intersection capable of reasonably calculating a vehicle collision time at the intersection and clearly performing a follow-up action thereof.

The aspects of the invention are not limited thereto but the other non-described aspects and features will be apparent to those skilled in the art from the following description.

A method of preventing a collision of vehicles at an intersection according to the present invention includes: calculating position information of a subject vehicle approaching the intersection and position information of an opposite vehicle approaching another approach path to the intersection; calculating intersection approach times of the subject vehicle and the opposite vehicle based on the position information; calculating an approach time difference between the intersection approach time of the subject vehicle and the intersection approach time of the opposite vehicle; and performing a follow-up action depending on the approach time difference.

In addition, performing the follow-up action may advance the subject vehicle in the current state when the approach time difference is larger than or equal to a first set time; perform a collision warning to the subject vehicle when the approach time difference is smaller than the first set time and larger than or equal to a second set time; and calculate target acceleration of the subject vehicle when the approach time difference is smaller than the second set time.

Further, when the approach time difference is smaller than the second set time, the calculated target acceleration may be informed to a driver.

Furthermore, when the driver does not change the acceleration according to the informed target acceleration, the acceleration of the subject vehicle may be automatically controlled according to the calculated target acceleration.

In addition, when the approach time difference is smaller than the second set time, the acceleration of the subject vehicle may be automatically controlled according to the calculated target acceleration.

Further, the target acceleration may be calculated by the following equation:

$$\frac{S - {V}_{0} t}{\frac{1}{2} t}$$

wherein S represents a distance to the intersection, V₀ represents a current speed, and t represents an intersection approach time.

Since the method of preventing the collision of the vehicles at the intersection has a simple and reasonable algorithm for preventing a collision of vehicles, a rapid and accurate countermeasure can be performed.

In addition, a clear follow-up action can be performed to further increase safety.

The effects of the present invention are not limited to the above-mentioned effects, and other additional effects will become apparent to those skilled in the art from the following description.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a view showing a case in which a subject vehicle and an opposite vehicle approach an intersection;

FIG. 2 is a view showing intersection approach times of the subject vehicle and the opposite vehicle;

FIG. 3 is a view showing a case in which the vehicles collide when the intersection approach times of the subject vehicle and the opposite vehicle are within the same range;

FIG. 4 is a view showing a case in which the intersection approach time of the subject vehicle is larger than that of the opposite vehicle;

FIG. 5 is a view showing a case in which the intersection approach time of the subject vehicle is smaller than that of the opposite vehicle; and

FIG. 6 is a view showing a follow-up action calculating process according to a first set time and a second set time.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Hereinafter, a method of preventing a collision of vehicles at an intersection according to the present invention will be described in detail with reference to the accompanying drawings.

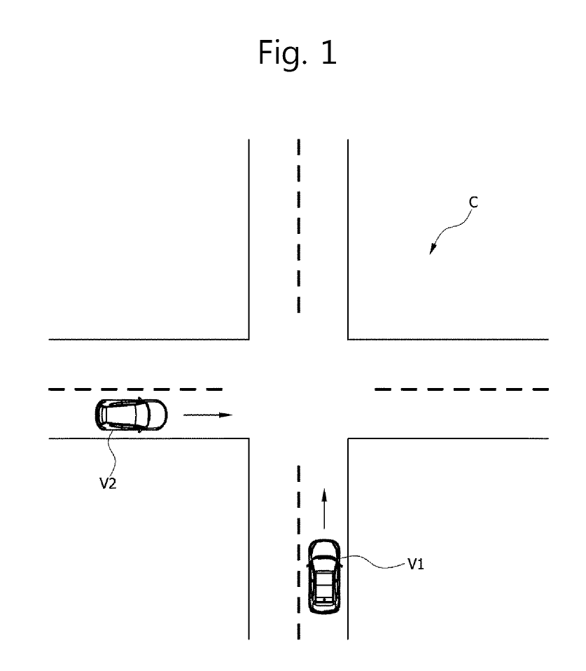

FIG. 1 is a view showing a case in which a subject vehicle V1 and an opposite vehicle V2 approach an intersection.

When the subject vehicle V1 and the opposite vehicle V2 simultaneously approach an intersection c as shown in FIG. 1, probability of a collision of both of the vehicles is present. Accordingly, in order to solve the problem, the present invention proposes a method of preventing a collision of vehicles at an intersection.

Hereinafter, the subject vehicle V1 is a vehicle in which an intersection collision prevention system is mounted, and the opposite vehicle V2 is a vehicle that approaches another approach path to the intersection c when a driver of the subject vehicle V1 approaches the intersection c.

First, a step of calculating position information of the subject vehicle V1 approaching the intersection c and position information of the opposite vehicle V2 approaching the other approach path to the intersection c is performed.

In this step, the intersection collision prevention system installed at the subject vehicle V1 calculates the position information of the subject vehicle V1 approaching the intersection c and the position information of the opposite vehicle V2 approaching the other approach path to the intersection c. That is, the intersection collision prevention system installed at the subject vehicle V1 can calculate current positions of the subject vehicle V1 and the opposite vehicle V2.

Here, the calculation of the position information can be performed using various means such as GPS, wireless communication, or the like, and may be performed by direct communications between the subject vehicle V1 and the opposite vehicle V2.

After the step, a step of calculating intersection approach times of the subject vehicle V1 and the opposite vehicle V2 based on the position information is performed.

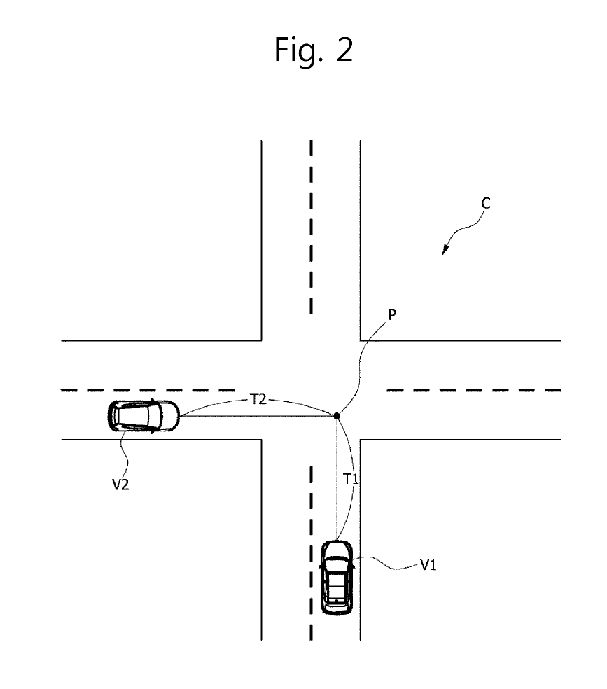

FIG. 2 is a view showing the intersection approach times of the subject vehicle V1 and the opposite vehicle V2.

As shown in FIG. 2, a distance to a cross point P of the intersection c can be calculated based on the position information calculated by the step of calculating the position information, and thus, the intersection approach time to be consumed until the subject vehicle V1 and the opposite vehicle V2 approach the intersection can be calculated in consideration of current speeds of the subject vehicle V1 and the opposite vehicle V2.

For the convenience of description, the intersection approach time of the subject vehicle V1 is set as T₁, and the intersection approach time of the opposite vehicle V2 is set as T₂.

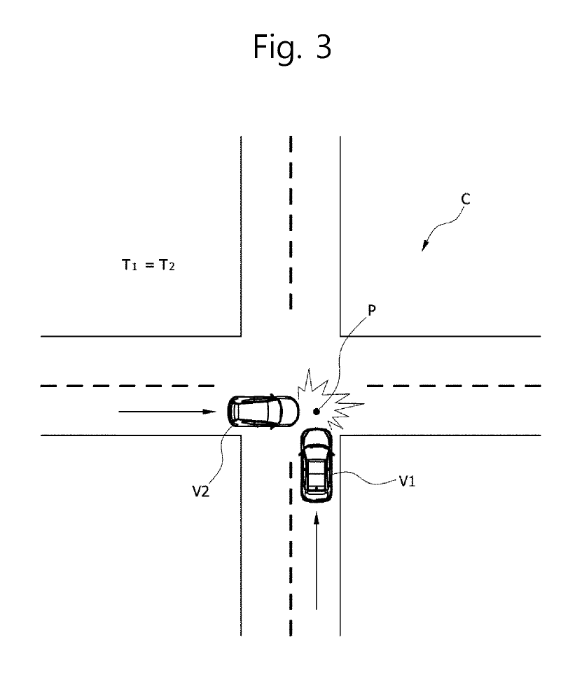

FIG. 3 is a view showing a case in which the vehicles collide when the intersection approach times of the subject vehicle V1 and the opposite vehicle V2 are within the same range.

As shown in FIG. 3, when the intersection approach time T₁ of the subject vehicle V1 and the intersection approach time T₂ of the opposite vehicle V2 are equal or similar to each other, the subject vehicle V1 and the opposite vehicle V2 simultaneously arrive at the cross point P to cause a collision of the vehicles. Here, approximate values of the intersection approach times T₁ and T₂ which may cause the collision of the vehicles may be determined in consideration of the whole length or the like of the vehicle.

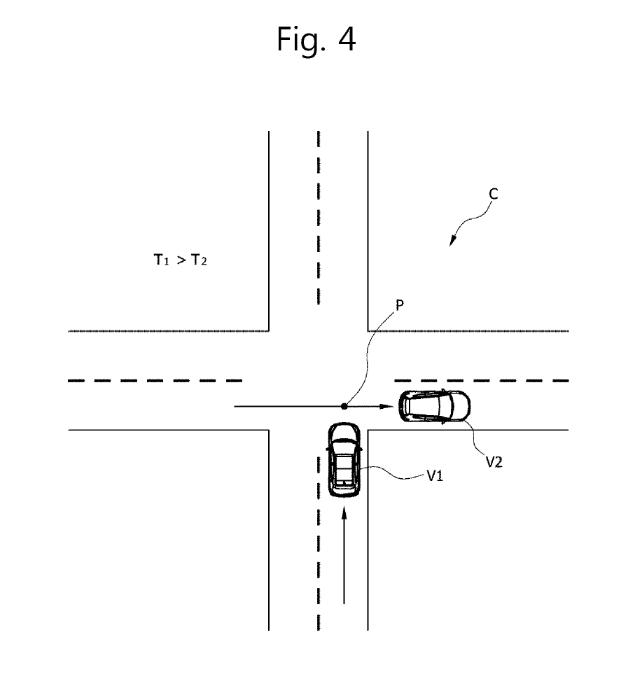

FIG. 4 is a view showing a case in which the intersection approach time T₁ of the subject vehicle V1 is larger than the intersection approach time T₂ of the opposite vehicle V2.

When the intersection approach time T₁ of the subject vehicle V1 is larger than the intersection approach time T₂ of the opposite vehicle V2 as shown in FIG. 4, since the opposite vehicle V2 first arrives at the cross point P, after the opposite vehicle V2 passes the cross point P, the subject vehicle V1 approaches the cross point P. Accordingly, in this case, the vehicles do not collide.

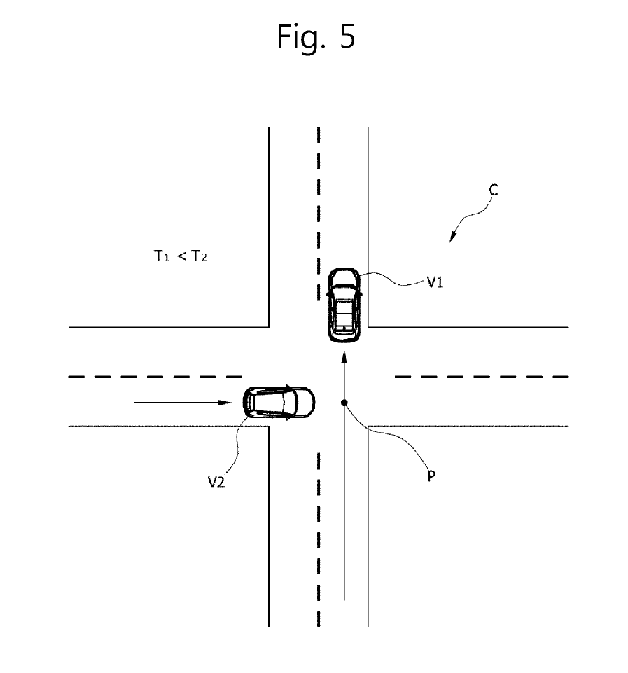

FIG. 5 shows a case in which the intersection approach time T₁ of the subject vehicle V1 is smaller than the intersection approach time T₂ of the opposite vehicle V2.

When the intersection approach time T₁ of the subject vehicle V1 is smaller than the intersection approach time T₂ of the opposite vehicle V2 as shown in FIG. 5, since the subject vehicle V1 first arrives at the cross point P, after the subject vehicle V1 passes the cross point P, the opposite vehicle V2 approaches the cross point P. Accordingly, also in this case, the vehicles do not collide.

As described above, in order to expect probability of a collision of the subject vehicle V1 and the opposite vehicle V2, after the step of calculating the intersection approach times, a step of calculating an approach time difference between the intersection approach time T₁ of the subject vehicle V1 and the intersection approach time T₂ of the opposite vehicle V2 is performed. Hereinafter, the approach time difference is set as T_{d}.

That is, when the approach time difference T_{d} is 0 or a set value approximate to 0, a collision of the subject vehicle V1 and the opposite vehicle V2 is expected, and when an absolute value of the approach time difference T_{d} departs from a set value approximate to 0, it is expected that the subject vehicle V1 and the opposite vehicle V2 do not collide.

Accordingly, a step of performing a follow-up action may be performed depending on the approach time difference T_{d}. The follow-up action is performed by the intersection collision prevention system, and various actions such as normal driving, deceleration, or the like, of the subject vehicle V1 may be performed according to circumstances.

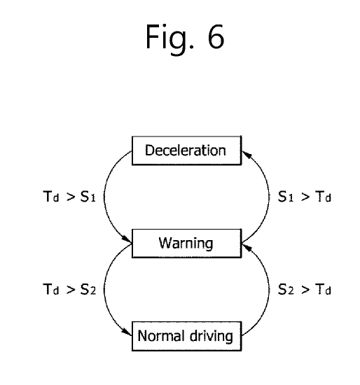

FIG. 6 shows a follow-up action calculating process according to a first set time S₁ and a second set time S₂.

In the embodiment, the follow-up action includes deceleration, warning, and normal driving, and the approach time difference T_{d} can be divided into the first set time S₁ and the second set time S₂.

Specifically, the first set time S₁ represents a boundary point between a point at which a collision of the subject vehicle V1 and the opposite vehicle V2 occurs and a point at which the collision of the subject vehicle V1 and the opposite vehicle V2 does not occur.

That is, when the approach time difference T_{d} is smaller than the first set time S₁, a collision of the subject vehicle V1 and the opposite vehicle V2 will occur, and when the approach time difference T_{d} is larger than the first set time S₁, the collision of the subject vehicle V1 and the opposite vehicle V2 will not occur.

In addition, the second set time S₂ represents a boundary point between a point at which the collision between the subject vehicle V1 and the opposite vehicle V2 does not occur but a hazard due to proximity driving is high and a point at which the collision between the subject vehicle V1 and the opposite vehicle V2 does not occur and a hazard due to proximity driving is low.

That is, when the approach time difference T_{d} is smaller than the second set time S₂ and larger than the first set time S₁, while the collision between the subject vehicle V1 and the opposite vehicle V2 does not occur, the proximity driving of the vehicles may cause a subsequent hazard, and when the approach time difference T_{d} is larger than the second set time S₂, probability of the subsequent hazard is decreased to enable the normal driving.

As described above, in the embodiment, a 3-step follow-up action including deceleration, warning, and normal driving is set with reference to the first set time S₁ and the second set time S₂.

That is, when the approach time difference T_{d} is larger than or equal to the first set time S₁, the subject vehicle V1 advances in the current state, when the approach time difference T_{d} is smaller than the first set time S₁ and larger than or equal to the second set time S₂, the subject vehicle V1 performs a collision warning, and when the approach time difference T_{d} is smaller than the second set time S₂, deceleration of the subject vehicle V1 can be performed.

Here, when the approach time difference T_{d} is smaller than the second set time S₂, while the system may automatically perform the deceleration of the subject vehicle V1, the system may calculate target acceleration before performing the deceleration and inform a driver of the target acceleration in advance.

That is, when the driver does not change the acceleration of the subject vehicle V1 for himself according to the informed target acceleration, the system can automatically control the acceleration of the subject vehicle V1 according to the calculated target acceleration.

In addition, the target acceleration may be calculated according to the following equation.

$$\frac{S - {V}_{0} t}{\frac{1}{2} t}$$

In the equation, S represents a distance to an intersection, V₀ represents a speed of the subject vehicle, and t represents an intersection approach time of the running subject vehicle. A system having high reliability can be implemented through calculation of the target acceleration.

As described above, the method of preventing a collision of vehicles at an intersection according to the present invention can divide the follow-up action into a plurality of steps and improve reliability of the system through calculation of the target acceleration to prevent the collision.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of preventing a collision of vehicles at an intersection, comprising:
calculating position information of a subject vehicle approaching the intersection and position information of an opposite vehicle approaching another approach path to the intersection;
calculating intersection approach times of the subject vehicle and the opposite vehicle based on the position information;
calculating an approach time difference between the intersection approach time of the subject vehicle and the intersection approach time of the opposite vehicle; and
performing a follow-up action depending on the approach time difference.

2. The method of preventing the collision of the vehicles at the intersection according to claim 1, wherein performing the follow-up action:
advances the subject vehicle in the current state when the approach time difference is larger than or equal to a first set time;
performs a collision warning to the subject vehicle when the approach time difference is smaller than the first set time and larger than or equal to a second set time; and
calculates target acceleration of the subject vehicle when the approach time difference is smaller than the second set time.

3. The method of preventing the collision of the vehicles at the intersection according to claim 2, wherein, when the approach time difference is smaller than the second set time, the calculated target acceleration is informed to a driver.

4. The method of preventing the collision of the vehicles at the intersection according to claim 3, wherein, when the driver does not change the acceleration according to the informed target acceleration, the acceleration of the subject vehicle is automatically controlled according to the calculated target acceleration.

5. The method of preventing the collision of the vehicles at the intersection according to claim 2, wherein, when the approach time difference is smaller than the second set time, the acceleration of the subject vehicle is automatically controlled according to the calculated target acceleration.

6. The method of preventing the collision of the vehicles at the intersection according to claim 2, wherein the target acceleration is calculated by the following equation:
$$\frac{S - {V}_{0} t}{\frac{1}{2} t}$$
wherein S represents a distance to the intersection, V₀ represents a current speed, and t represents an intersection approach time.
